(19) United States
(12) Patent Application Publication
(10) Pub. No.: US 2009/0204821 A1
(43) Pub. Date: Aug. 13, 2009

(54) DATA PROTECTION MECHANISM

(76) Inventors: Bjoern Fransson, Spanga (SE); Johan Zander, Malmoe (SE); Stefan Lynggaard, Lund (SE)

Correspondence Address: BIRCH STEWART KOLASCH & BIRCH, PO BOX 747, FALLS CHURCH, VA, 22040-0747, US

(21) Appl. No.: 12/296,650

(22) PCT Filed: Apr. 12, 2007
(86) PCT No.: PCT/SE2007/000346

§ 371 Date: Dec. 19, 2008

Related U.S. Application Data
(60) Provisional application No. 60/744,890, filed on Apr. 14, 2006.

(30) Foreign Application Priority Data
Apr. 12, 2006 (SE) 0600842-9

(51) Int. Cl. G06F 12/14; G06F 7/04

(52) U.S. Cl. 713/187; 726/27; 713/189

(57) ABSTRACT

A control system in a device allows for installation of application packages to impart different position data processing abilities to the device. The position data may be generated by an electronic pen, and the control system may be arranged in such a pen. Each application package comprises a license specification and an application program. The application program is configured to access the position data and device functions via the control system. The license specification provides for digital rights management and data protection. For example, the license specification may be used by the control system to verify an application program for installation in the device. Further, the license specification may cause the control system to selectively allow the application program to access a specific device function only if it is listed in the license specification.

### CROSS-REFERENCE TO RELATED APPLICATIONS

The present application claims the benefit of Swedish patent application No. 0600842-9, filed on Apr. 12, 2006, and U.S. provisional patent application No. 60/744,890, filed on Apr. 14, 2006, both of which being hereby incorporated by reference.

### FIELD OF THE INVENTION

The present invention generally relates to application programs for processing of position data, in particular position data generated by electronic pens.

### BACKGROUND ART

Electronic pens can be used for generation of information that electronically represents handwritten entries on a product surface.

Recently, electronic pens with audio feedback capability have gained success on the market. In particular, these audio-enabled pens are designed for the toy and learning market. Such pens are marketed under the product name “FLY™ Pentop Computer” by Leapfrog Enterprises, Inc.

A pen of this structure has a casing and a tip projecting from the same. An optical scanner is arranged in the casing to capture images of the surface on which the pen is operated. The surface may be a so-called dot-matrix paper comprising a position-coding pattern. When a user moves the tip on this surface, processing circuitry in the pen processes the images to electronically determine the position and movement of the pen on the surface. The pen has an audio function which means that it outputs audio signals via an integrated speaker in response to certain “hits” or movements of the tip on the dot-matrix paper.

The pen can be loaded with different application programs via cartridges that are sold together with dedicated dot-matrix paper products. A user loads an application program by physically attaching the cartridge to an interface at the back end of the pen.

As popularity grows, there is an increased likelihood of copying and illicit use of existing application programs. There is also an increased risk of unauthorized providers seeking to develop and sell application programs for the pen, which potentially could undermine the revenue stream of the original provider as well as cause problems with malicious code entering the pens.

### SUMMARY OF THE INVENTION

The object of the invention is to provide a technique for digital rights management and data protection with respect to application programs for processing of position data.

Generally, the objects of the invention are at least partly achieved by means of handheld devices, methods, and application packages according to the independent claims, preferred embodiments being defined by the dependent claims.

Still other objectives, features, aspects and advantages of the present invention will appear from the following detailed disclosure, from the attached dependent claims as well as from the drawings.

### BRIEF DESCRIPTION OF THE DRAWINGS

The invention will now be described in more detail with reference to the accompanying schematic drawings.

FIG. 1 illustrates an application program environment in a device.

FIGS. 2A-2B are views illustrating the arrangement of a control system for position-processing application programs in a pen and a pen-connected device, respectively.

FIGS. 3A-3C are views illustrating different ways of importing an application program into a pen or a pen-connected device.

FIG. 4 is a view illustrating the interior of an electronic pen that may implement the principles of the present invention.

FIG. 5 is a view illustrating different modules involved in a position decoding procedure.

FIG. 6 is a view to illustrate a logical division of an abstract position-coding pattern into a tree structure of addressable page units.

FIG. 7 is a view to illustrate some principal components of an application program package.

FIG. 8 is a view to illustrate a chain of licenses emanating from a root Administrator license.

FIGS. 9A-9C are views to exemplify details of different licenses issued in a chain of licenses.

FIG. 10 is a view to illustrate different scenarios of issuing licenses.

FIGS. 11-12 are views to exemplify verification of an application program for installation in a pen or pen-connected device.

FIG. 13 is a view to illustrate an implementation of the control system in FIGS. 1-3.

FIG. 14 is a view corresponding to FIGS. 9A-9C, in which sublicenses are created based on an alternative security model.

FIG. 15 is a view to illustrate steps in verifying authenticity and integrity of the sublicenses in FIG. 14.

### DETAILED DESCRIPTION OF THE INVENTION

The following description is focused on the distribution and installation of so-called paplets. A paplet is a dedicated application program which can be installed in a handheld device to provide a specific functionality. Specifically, the paplet receives and processes position data, and is capable of selectively invoking resources of the device. For example, the paplet may cause data to be output via an integrated display or speaker, or data may be stored in a memory in the device, or be output via a communications interface of the device.

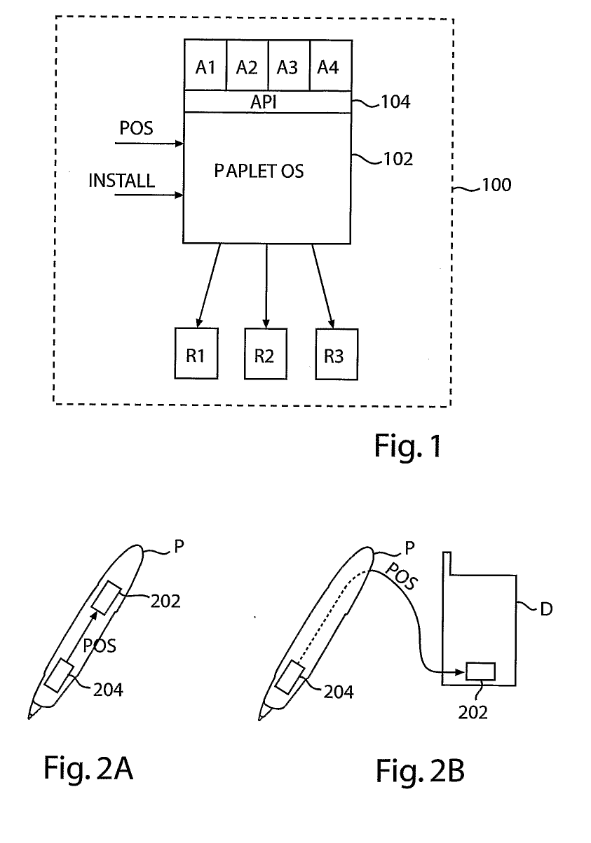

FIG. 1 schematically illustrates the environment in which paplets are executed in a device. The device 100 has a dedicated paplet control system (Paplet OS) 102, which is capable of installing paplets, and subsequently executing one or more the installed paplets A1-A4. The Paplet OS 102 exposes a Paplet API (Application Programming Interface) 104 to the paplets, by means of which installed paplets can access different resources R1-R3 of the device 100. The Paplet OS also distributes incoming positions to the installed paplets A1-A4.

In one embodiment, the Paplet OS is a Java-based runtime system optimized for embedded systems with limited memory and processing power. In such an embodiment, the paplets are programs written in Java language to be run in real time by the Paplet OS. The Paplet OS may thus comprise conventional Java components, such as a Java Virtual Machine, core classes and supporting Java platform libraries, as well as a custom Paplet API. The Java Virtual Machine operates on top an operating system of the device. In one conceivable embodiment, the core classes are based on CLDC (Connected Limited Device Configuration) which is a framework with a base set of classes and APIs for J2ME applications.

It should be realized, however, that the Paplet OS could be based on any other software platform for running dedicated paplets, for example Palm OS, Windows CE, Symbian OS, VxWorks, eCos, QNX, LynxOS, Linux derivaties, etc. Alternatively, the Paplet OS could be a totally proprietary control system.

The Paplet OS may be implemented to receive position data generated by a position recorder in an electronic pen. The position recorder may generate relative positions only, e.g. to represent the movement pattern of the pen in proximity to a surface. Alternatively, the position recorder may generate absolute positions that also represent the precise location of the pen on the substrate. As will be further described below, the generated position data may also be indicative the substrate itself.

A multitude of different paplets may be available to provide different functionality. For example, one paplet may be dedicated to storing positions in a memory in the device, whereas another paplet may be dedicated to deriving media files from a network server via a communications interface of the device, and to play these files to the user via multimedia resources in the device.

Different paplets may be registered with the Paplet OS to receive different positions. For example, one paplet may be dedicated to receive positions only within a confined position set, or positions belonging to a particular substrate. Thus, this paplet is only invoked when the Paplet OS receives positions that fall within the confined set of positions or that originate from the particular substrate. In one example, the paplet may be dedicated to processing and/or storing positions that belong to a particular form, and to provide assistance or guidance to a user that enters handwritten data on the form using the electronic pen. The paplet may even validate that the form is properly filled-in, and if deemed necessary further instruct the user on what and how to correct.

Thus, some paplets may allow the pen user to directly interact with pen strokes as they are generated by the pen, by interactive feedback being provided by the paplet, e.g. by the paplet invoking a screen or a speaker to output specific feedback data.

In one implementation, shown in FIG. 2A, the Paplet OS 202 is arranged in an electronic pen P to receive positions from a position recorder 204 essentially in real time as they are generated.

In another embodiment, shown in FIG. 2B, the Paplet OS 202 is arranged in a separate handheld device D, here exemplified by a mobile phone, which receives positions from the electronic pen 200 via a wired or wireless communication link. Depending on implementation, the positions may or may not be provided to the Paplet OS 202 essentially in real time as they are generated.

The pen-connected device D may be any type of electronic data processing device, be it handheld or stationary, that is capable of receiving position data from a position recorder in a pen P. Examples include mobile phones, PDAs, laptop computers, game consoles, PCs, home entertainment systems, television systems, etc.

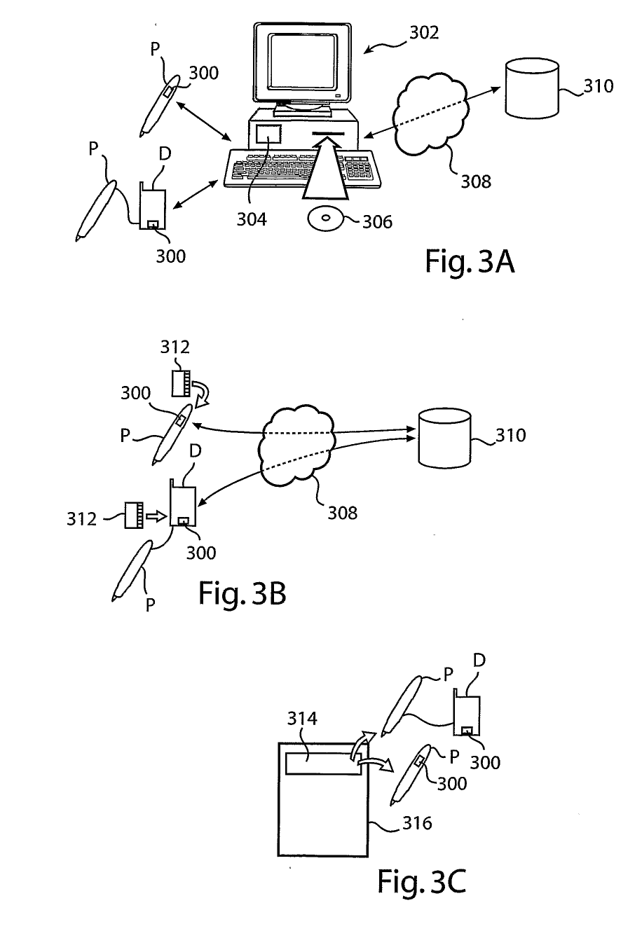

FIGS. 3A-3C illustrate different ways of importing a paplet into a pen P or into an auxiliary device D connected to the pen P, for installation in association with a Paplet OS 300.

In FIG. 3A, the pen/device P, D is tethered or wirelessly connected to a local paplet installation device 302, e.g. a PC running a paplet installation program 304. Paplets could be provided to the installation device 302 via a suitable data carrier 306, such as a CD-ROM or DVD. Alternatively, the local installation device 302 could connect via a network 308 to a paplet server 310. The installation device 302 may then be operated to select a paplet for retrieval from the server 310 and to provide to provide the retrieved paplet to a memory of the pen/device P, D, e.g. via an ftp server in the pen/device. Alternatively, a paplet may be automatically selected by the installation device 302, based on a position received from the pen/device. Thus, by operating the pen P on a particular substrate which is associated with a particular set of positions, the installation device 302 is automatically caused to retrieve an associated paplet for installation, e.g. from the carrier 306 or the server 310, and to provide the paplet to the pen/device.

In FIG. 3B, the pen/device P, D directly connects to the paplet server 310 via a wireless network interface. Here, the paplet is suitably selected from the pen/device, either by the paplet server 310 locating and providing an appropriate paplet based on position data received from the pen/device, or by the user selecting a paplet on the paplet server via a web browser in the device D. FIG. 3B also illustrates the further variant of providing the paplet on a memory unit 312 which is removably installed in the pen/device to be accessed by the Paplet OS 300. The memory unit 312 may be in the form of a card or a cartridge of any known type, such as SD card, CF card, SmartMedia card, MMC, Memory Stick, etc.

In FIG. 3C, the paplet is encoded as a graphical code 314 on a substrate 316, and the pen/device is capable of sensing the graphical code 314 and inferring the paplet from the sensed data. Thus, the paplet may be imported by the pen user operating the pen to read the code 314 off the substrate 316. The paplet is then installed in either the pen P or the auxiliary device D, depending on the location of the Paplet OS 300. Many large-capacity codes are available for such encoding, such as two-dimensional bar codes or matrix codes. Further examples of suitable codes, and methods for their decoding, are given in Applicant's prior publications: US 2001/0038349; US 2002/0000981 and WO 2006/001769.

It should be realized that the development/distribution/installation/use of a paplet may be associated with a fee. To secure return of investment, it may be desirable to introduce a mechanism for digital rights management (DRM) with respect to paplets. Such a DRM mechanism could have at least one of the following properties:
1. It should be possible to limit the use of a paplet to a specific user, in order to prevent redistribution and unintended usage of paplets.
2. It should be possible to install a paplet in multiple pens/devices (while still controlling which pens/devices). For example, the same paplet could be installed on all pens/devices in a class room or even in a school.
3. It should be possible for one pen/device to be used by multiple users (combo usage). For example, the pen/device may execute both paplets belonging to a home user, and paplets belonging to a school.
4. It should be possible to control and specify constraints for paplet developers.

It may also be desirable to provide a security mechanism to prevent malicious code from being installed by the Paplet OS.

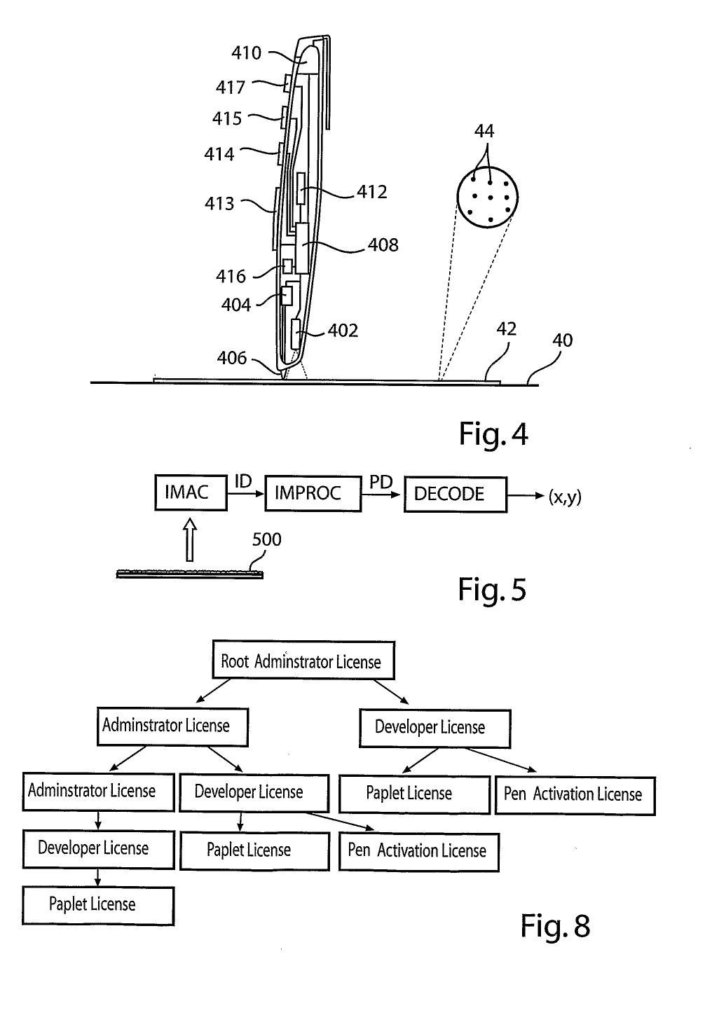

A currently preferred implementation of a paplet protection mechanism that has all of these desired properties will be described further below. For ease of understanding only, this mechanism will be described with reference to a particular electronic pen system developed by the Applicant. A brief summary of this system will now be given with reference to FIGS. 4-6.

An embodiment of an electronic pen 400 is shown in FIG. 4. The pen has a camera system 402 which is triggered to continuously capture images (typically at a rate of 70-100 frames per second) by a proximity sensor 404 indicating that a pen tip 406 is in close enough proximity to a surface 40. The surface 40 is printed with a position-coding pattern (dot pattern) 42 that codes absolute positions based on displacements of dots 44 from a regular grid formation. The images are processed by one or more data processors 408 in the pen to derive a sequence of positions, typically one for each image. The resulting positions are then either transferred via a communications interface 410 to an auxiliary device for receipt by the Paplet OS, or they are processed by a Paplet OS running on the data processor 408 in the pen. The pen also has a memory block 412 that includes both working memory and persistent-storage memory. Software is stored in the memory block 412 and is executed by the data processor 408 to provide an overall pen control system for the operation of the electronic pen, as well as the Paplet OS. Each pen also has a unique identity, a pen ID, which is stored as a fixed property in the memory block 412. Also, each pen stores the public key or the public key certificate of a top controlling actor (TCA). The pen may also have further hardware resources such as a display 413, a speaker 414, a microphone 415, a vibrator 416, one or more indicator lamps 417, etc.

The pen implements a sequential decoding procedure which is schematically illustrated in FIG. 5. An image acquisition module (IMAC) controls the camera system to capture an image of an encoded surface 500. Corresponding image data (ID) is then received and processed by an image processing module (IMPROC) which calculates the center point of all dots in the image and outputs processed data (PD) as a list indicating the location of all dot center points in the image. This list (PD) is received by a decoding module (DECODE) which processes the list to calculate an absolute position, typically in the form of a pair of coordinates (x,y). Here, it should be noted that the IMPROC and/or DECODE modules may alternatively be located outside the pen, i.e. in the auxiliary device.

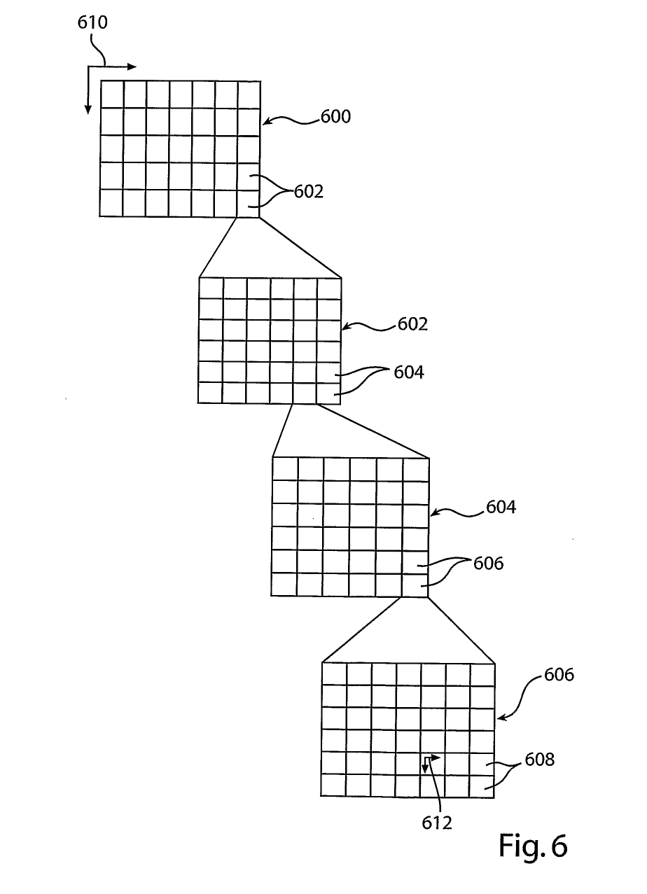

The position-coding pattern is huge; much larger than any conceivable substrate. In a commercially available embodiment, the dot pattern has a size of about 60 million km². This makes it possible to logically divide the pattern into confined areas, denoted pattern pages, which are individually addressable in a hierarchy of pattern page groups. The positions encoded within each pattern page are unique to this pattern page. An example of a pattern subdivision is given in FIG. 6, where the pattern 600 contains “segments” 602 which in turn are divided into a number of “shelves” 604, each containing a number of “books” 606 which are divided into a number of “pattern pages” 608. A certain pattern page 608 in the abstract pattern can be referenced by a page address of the form: segment.shelf.book.page. A page address may also be used to reference a set of pattern pages, e.g. by using the notation 1.2.3.x, 1.2.x.x, or 1.x.x.x, where x denotes all pattern pages of a specific book, shelf, and segment, respectively.

One or more pattern pages may be wholly or partly applied to a substrate, e.g. by digital or offset printing, to graphically encode positions on the substrate.

It should be noted that the encoded positions are global positions in a global coordinate system 610 of the overall pattern 600. The global position may be converted, with knowledge of the pattern subdivision, into a so-called logical position, which is given by a page address and a local position in a local coordinate system 612 with a known origin on each pattern page.

Different implementations of the pen hardware, the decoding procedure, the position-coding pattern and its subdivision in pattern pages are, i.a., found in Applicant's U.S. Pat. No. 6,667,695; US 2003/0061188; WO 2006/004505; WO 2006/004506; and WO 2005/057471, and references therein.

In the embodiment to be described in the following, a paplet is associated with one or more pattern pages, i.e. it is designed to process positions belonging to a specific set of pattern pages. For reasons of simplicity, the following description is limited to electronic pens. However, it should be realized that the description is equally applicable to other devices with a Paplet OS, e.g. the auxiliary device (D in FIGS. 2-3).

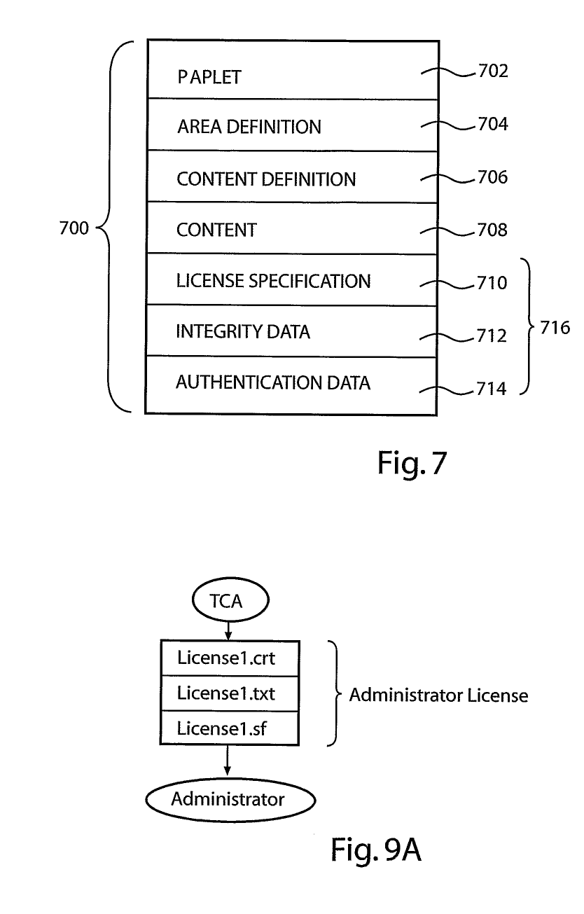

Paplets are suitably distributed in paplet packages 700 which, in addition to a paplet 702, may include associated area definition data 704 and content definition data 706, as indicated in FIG. 7. The area definition data 704 specifies the location of predefined areas, if any, on the pattern page(s) associated with the paplet. Each area may be identified via an area ID which is unique within the pattern page. The paplet 702 may associate dedicated processing instructions with these predefined areas (via the area ID). The content definition data 706 associates one or more of the predefined areas in the area definition data with dedicated content (via the area ID). This content may be pre-stored in the pen and/or it may be included in the paplet package in the form of media files 708 or links to media files on an external device, such as a network server.

The area definition data 704 and/or content definition data 706 may be included in the paplet package as one or more separate files which can be installed in the pen/device to be accessed by the Paplet OS when running the paplet. Alternatively, this data may be incorporated in the paplet code.

In the described embodiment, the Paplet OS is Java-based, and the paplet is embodied as one or more class files. Preferably, the paplet package is implemented as a jar file (Java Archive).

To implement a paplet protection mechanism as discussed above, the paplet package 700 also includes a license specification 710, integrity data 712, and authentication data 714, collectively referred to as “Paplet License” 716, as shown in FIG. 7. The license specification 710 is used by the Paplet OS to validate the paplet 702, and it also controls the rights of the paplet when run by the Paplet OS. The integrity data 712 allows the Paplet OS to verify that the paplet 702 and the license specification 710 have not been tampered with. The authentication data 714 allows the Paplet OS to verify the identity of the issuer of the paplet 702 and the license specification 710.

The license specification 710 includes values for a number of predetermined parameters, for example any of the following:

License ID

Parent License ID

License Name

License Holder

License Type

Sublicensing Rights

Creation Date

Validity Period

Pen ID Range

User ID

Page Range

Functionality

License ID is an ID set by the issuer or the holder to identify the license. Parent License ID is the ID of the (parent) license from which the instant license has been sublicensed. License Name indicates the name of the license in clear text, and License Holder indicates the name of the license holder in clear text. License Type indicates a license category, and Sublicensing Rights controls sublicensing privileges, as will be further described below. Creation Date indicates the date when the license was created. Validity Period indicates when the license expires, for example via an explicit expiry date, a time period from the creation date, or a limitation in the number of times that a paplet can be executed by the Paplet OS in a pen. Pen ID Range indicates one or more specific pens for which the license is valid. User ID indicates a specific user for which the license is valid. Page Range indicates the page addresses for which the license is valid. Functionality indicates the paplet's privileges to access resources in the pen. Functionality may include any one of the following sub-parameters, which may be set to true or false depending on access privilege:
Store—access to internal memory for storage of data
Send—access to communications interface to output data
Encrypt—access to encryption facilities to encrypt data
Barcode—access to barcode reading and interpreting facilities
Dotcode—access to large-capacity code reading and interpreting facilities
Stream—access to communications interface to output data in near-real time
HWR—access to hand-writing recognition facilities to convert positions to computer text
TTS—access to text-to-speech conversion facilities to convert computer text to speech
Audio—access to audio output facilities
Video—access to video output facilities
Display—access to display facilities
Mic—access to audio recording facilities
External—access to nearby external devices over communications interface
Network—access to network devices over communications interface

Licenses are not only used to validate and control the privileges of a paplet, but are also used to control rights and privileges of parties involved in the development and distribution of paplets. Thus, a chain of licenses may be established, which can be traced backwards from a paplet license installed in a pen to a root license issued by a top controlling actor. In other words, different actors may acquire a license which controls their rights and privileges, e.g. with respect to sublicensing and paplet development and distribution.

One key feature of sublicensing control is that the values of certain controlling parameters in a sublicense may not exceed the boundaries set by the corresponding parameters in the parent license. Such controlling parameters may include Validity Period, Pen ID, Page Range and Functionality. For example, the validity period of a sublicense may not be set beyond the validity period of the parent license. Similarly, a sublicense can only be granted for the same pens (given by Pen ID Range) as the parent license, or a subset thereof. Likewise, a sublicense can only be granted for the same pattern pages (given by Page Range) as the parent license, or a subset thereof. Further, a sublicense can only give the same access privileges under Functionality as the parent license, or less.

The license may allow a top controlling actor to select the parameters that are to be controlling for sublicensing.

There are a number of different license types (indicated by the License Type parameter): Administrator License, Developer License, Pen Activation License, and Paplet License.

The Administrator License gives the holder the right to create new licenses. The Sublicensing Rights parameter indicates the license types that are allowed to be created. An Administrator License cannot be installed in a pen, nor can a Developer License. A top controlling actor has a root Administrator License with full permissions which is used to create sublicenses to selected actors. One actor can be given the right only to create Developer Licenses, whereas another actor could be given the right to sublicense Administrator Licenses further. The purpose of the Administrator License is to give the holder the right to a specific part of the pattern, to certain kind of functionality, and to sublicense. FIG. 8 illustrates an example of a chain of licenses.

As will be further exemplified below, the Administrator License contains the (public key) certificate of the holder and is signed by the issuer. The signing of the certificate assures that only the holder can use the license, and the signing of the license specification assures that the license can not be altered.

The Developer License is issued to paplet developers by an Administrator License holder. It gives the holder the right to a specific part of the pattern, to certain kind of functionality, and to create/manage Paplet Licenses.

The Developer License is unique for each developer and contains the (public key) certificate of the developer, the corresponding private key being used to sign paplets, as will be further described below.

The Pen Activation License is installed in the pen to associate a user ID to the pen ID, which is a unique and fixed ID stored in the pen memory during production. This allows for paplets to be licensed for specific users, not only for specific pens. A user in this context can be a single user, a family, an organization, a company, etc. The Pen Activation License allows for sharing of paplets within a restricted group. For example, a paplet may be licensed to the ‘ABC elementary school’. The school can share the same paplet between pens, but each pen must be activated before usage, by installation of a Pen Activation License in the each pen. Also, if a pen breaks, a user can buy a new pen and associate it to the appropriate user ID via a Pen Activation License. Already bought paplets can then be used in the new pen.

A pen can be activated for multiple user IDs, for example users ‘John Doe’ and ‘ABC elementary school’, by multiple Pen Activation Licenses being installed in the pen. This allows for usage of paplets signed for different user IDs in the same pen.

The Paplet License is part of a paplet package. A paplet can be installed in a pen, provided that its associated Paplet License has either a valid user ID or pen ID value. If the license contains a user ID, the pen must have been activated for that user ID for successful installation of the paplet. If the license contains a pen ID, the pen may during installation verify that this matches the pen ID of the pen. The Paplet License guarantees that the paplet can only be used by specific users or pens, that the paplet only uses positions from a licensed page range, and that the paplet only uses licensed functionality.

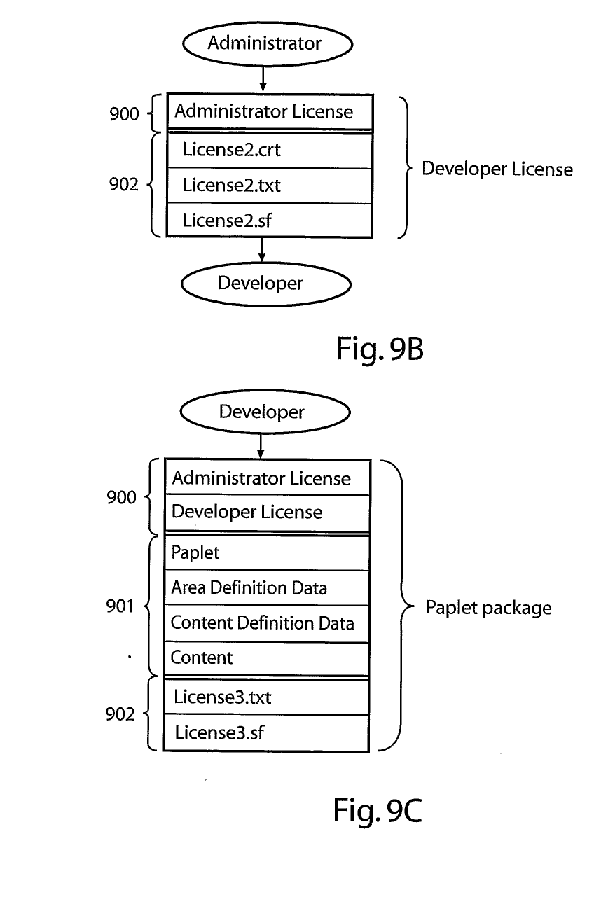

FIGS. 9A-9C shows an example of a licensing chain in which public key certificates are used to provide authenticity, and digital signatures are used to provide integrity.

In FIG. 9A, an Administrator License has been issued by a top controlling actor (TCA). The Administrator License contains the certificate of the Administrator (License1.crt), the Administrator license specification given by TCA (License1.txt), and a digital signature (License1.sf) of the Administrator license specification and the Administrator certificate. The digital signature has been created using the TCA private key, which corresponds to the public key that is pre-stored in the pens.

The Developer License in FIG. 9B is issued by the holder of the Administrator License of FIG. 9A (“the Administrator”). The Developer License has a validation section 900 which stores the Administrator License, and a license section 902 which stores the certificate of the Developer (License2.crt), the Developer license specification given by the Administrator (License2.txt), and the digital signature (License2.sf) of the Developer license specification and the Developer certificate. The digital signature has been created using the Administrator's private key, which corresponds to the public key in the Administrator certificate (License1.crt).

The paplet package in FIG. 9C is issued by the holder of the Developer License of FIG. 9B (“the Developer”). The paplet package has a validation section 900 which stores the Administrator and Developer Licenses, a paplet section 901 which includes the paplet and any associated files (e.g. area definition data, content definition data, and content files), and a license section 902 which stores the paplet license specification given by the Developer (License3.txt), and the digital signature (License3.sf) of all paplet section data and the paplet license specification. The digital signature has been created using the Developer's private key, which corresponds to the public key in the Developer certificate (License2.crt).

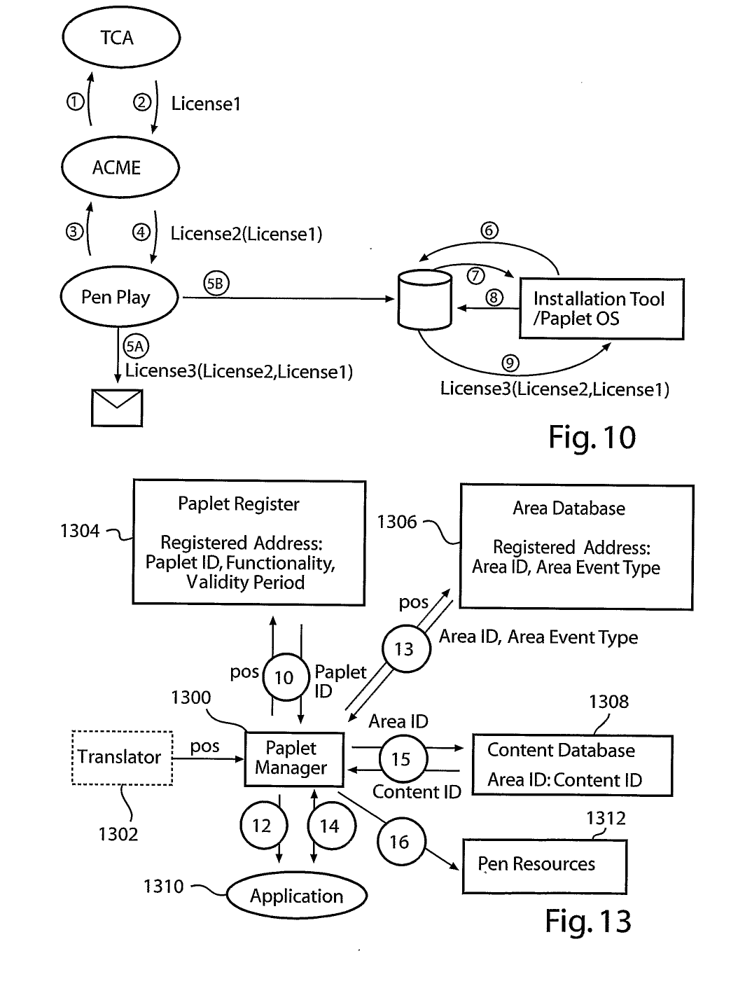

To further clarify the use and purpose of the different license types, a few scenarios will be briefly discussed with reference to FIG. 10.

First, the top controlling actor (TCA) wishes to give the company Acme Inc. the right to manage a part of the pattern. In this case, TCA is the holder of a root Administrator License and wishes to issue another Administrator License to Acme Inc. with restrictions on the pattern area. This may involve the following steps: Acme creates a (public key) certificate; Acme sends a license request and its certificate to TCA (step 1); TCA creates the Administrator License (“License1”) based on the license request; TCA sends the license to Acme (step 2); and Acme imports the license into a License Manager Tool and is all set up to issue sublicenses.

To develop paplets, PenPlay Corp. needs a Developer License which it may receive from Acme. This may involve the following steps: PenPlay creates a (public key) certificate; PenPlay sends a license request together with its certificate to Acme (step 3); Acme creates the Developer License (“License2”), based on the license request, using the License Manager Tool; Acme sends the license to PenPlay (step 4); PenPlay imports the license into a Paplet Development Tool, whereupon PenPlay is allowed to develop a paplet and create a paplet package for installation. If PenPlay wishes to associate the paplet with a user ID already at this stage, PenPlay adds a Paplet License (“License3”) to the paplet package specifying the user ID (step 5A). Otherwise, the paplet package may be uploaded for sale on a website (step 5B). Depending on implementation, PenPlay may or may not add a Paplet License to the paplet package before sending it to the website provider. The website provider may have an Administrator License with the right to create Paplet Licenses. Thus, a Paplet License may be created and added to the paplet package by the website at the time of purchase, see below.

When a user wants to buy and install a paplet online from the website, the user must first register the pen to the user, unless this has been done previously and the pen thus already contains the requisite Pen Activation License. The registration may involve the steps of: transmitting the pen ID to the website (step 6); creating at the website a Pen Activation License, containing the pen ID and user ID; providing and installing the Pen Activation License in the pen, the activation being successful if the pen ID of the license matches the pen ID of the pen (step 7). The user may then buy a paplet by providing the user ID to the website (step 8). The website creates a Paplet License, containing the user ID, and adds this license to the paplet package. The paplet package is then downloaded and installed in the pen (step 9).

Alternatively, the activation step is omitted, and the Paplet License is instead created only to define one or more pen IDs. Here, the Pen ID Range parameter may specify “all”, thereby making the paplet available for installation in any pen.

As indicated by step 5A, paplet packages can also be distributed on a data carrier, such as a CD, etc, or as encoded in a large-capacity graphical code. In this scenario, however, there is no simple way of adding the Paplet License at the time of purchase. Instead, the developer should have added a Paplet License to the paplet package before storing it on the data carrier. This scenario might be more suitable for large-scale solutions: A paplet is developed for Elementary School ABC. Already when the paplet package is created, the developer signs it for use by a user ID selected by Elementary School ABC, or for use by a set of pen IDs belonging to Elementary School ABC.

During installation of a paplet package, the Paplet OS in the pen will verify the paplet package. If the paplet package is not consistent or valid, the Paplet OS will not register the paplet for execution.

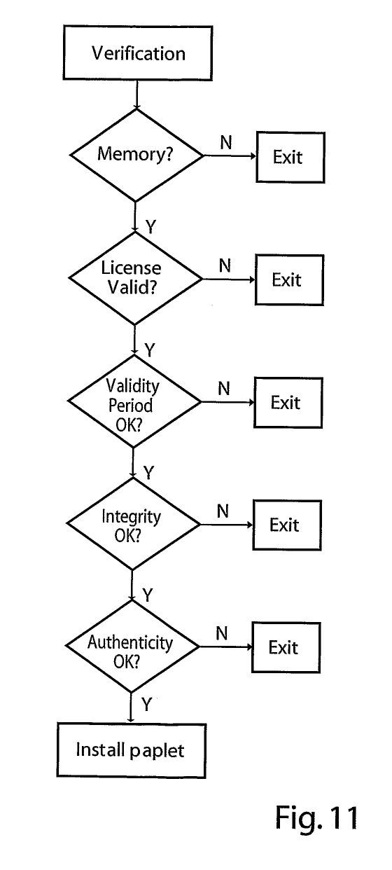

In this verification, shown in FIG. 11, the Paplet OS may first check that memory is available in the pen for the paplet. The Paplet OS may then check that the license specification for the paplet (license3.txt) is valid, by deriving the next-level license specification (license2.txt) from the validation section of the paplet package, and checking that the values of the controlling parameters in license3 lies within the boundaries set by the controlling parameters in license2. The Paplet OS may also make corresponding checks for further levels of license specifications (license 2 vis-a-vis license1). The Paplet OS may also check the actual values of parameters in license 3, e.g. by matching the Validity Period value against the current time generated by a time circuit in the pen to verify that the validity period has not expired. The Paplet OS may then check the authenticity of the paplet package, by verifying the chain of certificates in the paplet package. The Paplet OS may also check the integrity of the paplet package by verifying the included digital signatures. This may be done by the Paplet OS first validating the top-most signature created by the TCA, by using the TCA public key which is pre-stored in the pen, and then iterating down through the sequence of digital signatures in the validation section (900 in FIG. 9), ending by validating the digital signature of the paplet (license3.sf). If any one of the above checks fails, the installation is aborted and a corresponding error message may be issued.

Similarly, the Paplet OS may execute the verification process of FIG. 11 before installing a Pen Activation License.

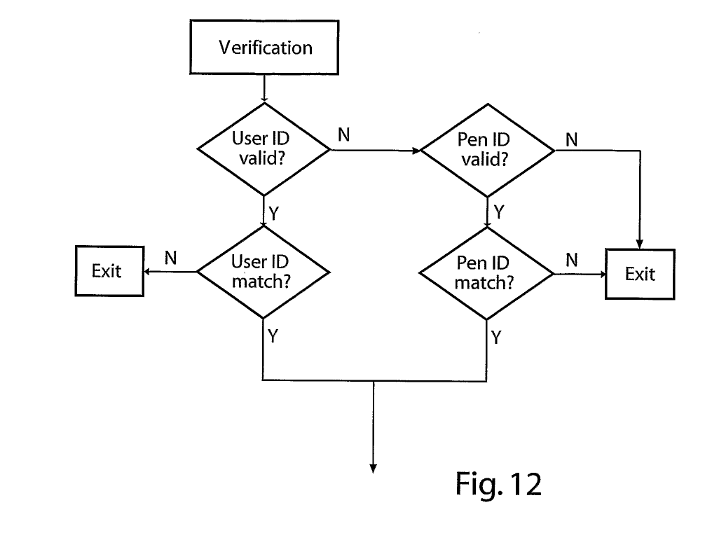

In addition to the above verification process, the verification of a paplet may also include checking if the license specification includes a valid value of the User ID parameter, as shown in FIG. 12. If yes, the Paplet OS verifies that this value matches one of the User IDs that have been installed by the Paplet OS via Pen Activation Licenses. If a match is found the verification proceeds, otherwise it is aborted. If the User ID parameter, or at least a valid value, is missing from the license specification, the Paplet OS checks if the license specification contains a valid value of the Pen ID Range parameter. If yes, the Paplet OS verifies that this value matches the Pen ID stored in the pen, i.e. that the Pen ID of the pen is included among the Pen IDs given by the Pen ID Range parameter. If a match is found the verification proceeds, otherwise it is aborted.

Alternatively or additionally, the verification may comprise matching a Pen Provider parameter value in the license specification against a pre-stored pen provider indication in pen memory. The pen provider indication may indicate the manufacturer or distributor of the pen. Thus, a paplet package may be associated with a specific pen provider, such that the included paplet can only be installed in pens originating from this pen provider.

After successful installation, the Paplet OS stores at least part of the paplet license specification (as will be described further below with reference to FIG. 13), as well as the paplet and its associated files, in pen memory.

In an alternative embodiment, the paplet verification process is executed by a Paplet Installation Tool (indicated in FIG. 10) instead of the Paplet OS. After successful verification, the Paplet Installation Tool uploads the paplet package to the pen for installation by the Paplet OS.

It should also be mentioned that a corresponding verification process may be executed by aforesaid License Manager Tool and Paplet Development Tool when a license is imported therein.

The Paplet Installation Tool, the License Manager Tool and the Paplet Development Tool may all be implemented by software running on a conventional processor, e.g. in a personal computer or on a server.

FIG. 13 shows details of one embodiment of the Paplet OS. Here, the Paplet OS comprises a Paplet Manager 1300 which handles paplet initiation and shut-down based on the received positions, as well as executes basic operations on behalf of the running paplets (denoted applications in the following). In this embodiment, the Paplet OS operates on logical positions (each consisting of a page address and a local position), which are generated by a Translator module 1302 based on the global positions generated by the decoding module. The Translator module 1302 may or may not be part of the Paplet OS.

Applications communicate with the Paplet Manager 1300 via the above-mentioned Java Paplet API. The Paplet OS further comprises a Paplet Register 1304 which associates page addresses with paplets, an Area Database 1306 which represents the area definition data for the paplet currently run by the Paplet OS, and a Content Database 1308 which represents the content definition data for the paplet currently run by the Paplet OS.

When a paplet is installed in the pen, after successful verification, an entry is added to the Paplet Register 1304 to associate the paplet, via a paplet ID, with a particular page address (registered address), given by the Page Range parameter in the Paplet License. Any suitable identifier may be used as paplet ID, such as a unique number, the paplet name (Java class name), the jar file name, the License ID, etc. The entry may be made automatically by the Paplet Manager 1300 deriving adequate data from the paplet package. The entry may also include Functionality parameter values and Validity Period of the paplet, as given by its license specification.

The Paplet Manager 1300 continuously maps the received positions against the Paplet Register 1304 (step 10). Whenever a position falls within a registered address, the corresponding paplet is launched to control the interaction between the user and a position-coded product (step 12). Recalling that the paplet is a class file, launching the paplet involves locating and instantiating the Java class file to create an object, which forms a running application. Before launching the paplet, the Paplet OS may check that the Validity Period of the paplet is still valid.

The Paplet Register 1304 may also associate paplets with gestures, in addition to page addresses. Thus, certain paplets may only be launched when a received sequence of positions (pen stroke) both belong to the appropriate part of the pattern and form the appropriate gesture.

When a paplet is launched by the Paplet Manager 1300, the corresponding area definition data is loaded into the Area Database 1306. Similarly, the corresponding content definition data is loaded into the Content Database 1308.

The Paplet Manager 1300 continuously maps the received positions against the Area Database 1306 (step 13). Whenever a position falls within an area with an area ID in the Area Database 1306, the Paplet Manager 1300 generates a corresponding area event which is made available to the running application 1310 (step 14). The content of the area event may be given by an Area Event Type associated with the area ID in the Area Database 1306. The Area Event Type for different areas may be included in the area definition data of the paplet package (704 in FIG. 7). Depending on Area Event Type, the area event may thus include the area ID, and optionally the received position and/or an enter/exit indication that the received position, in relation to preceding/succeeding positions, is the first/last position that falls within the area. The area event may cause the Paplet Manager 1300 (or the application 1310) to make a look-up in the Content Database 1308 to identify any content associated with the area ID (step 15). In its processing of the area events, the application 1310 may demand access to internal resources 1312 of the pen, such as internal memory, communications interface and associated software, speaker and associated software, microphone and associated software, screen and associated software, text-to-speech (TTS) conversion software and/or hardware, handwriting recognition software and/or hardware, barcode reading software and/or hardware, data encryption software and/or hardware, etc. The Paplet Manager 1300 gives such access (step 16) only after checking the access rights given by the Functionality parameter values associated with the paplet. It should be noted though, that only a subset of all available device functions in the pen may be subject to access control via the license specification. Thus, there may be “public” device functions that are accessible to all paplets.

The invention has mainly been described above with reference to a few embodiments. However, as is readily appreciated by a person skilled in the art, other embodiments than the ones disclosed above are equally possible within the scope and spirit of the invention, which is defined and limited only by the appended patent claims.

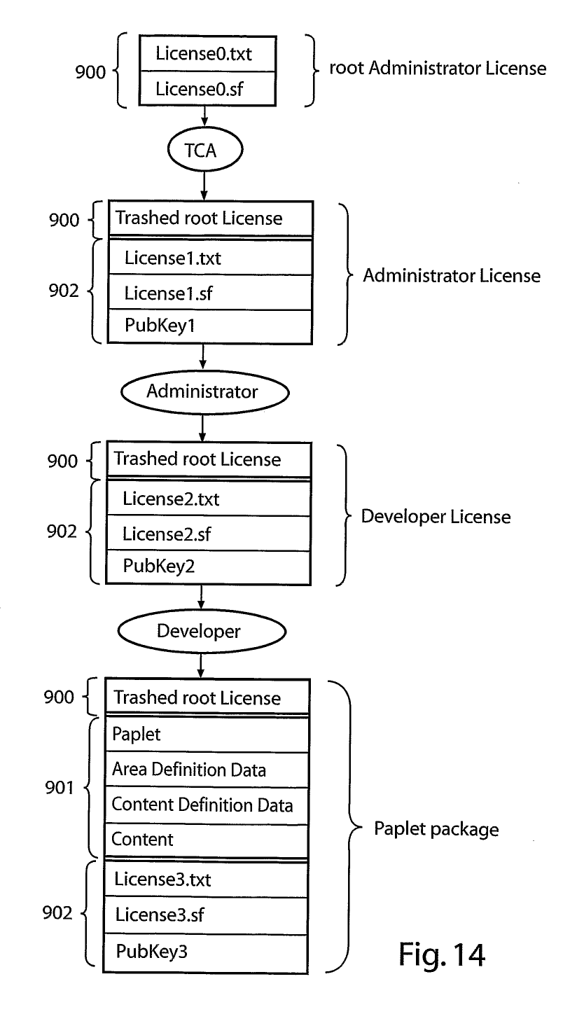

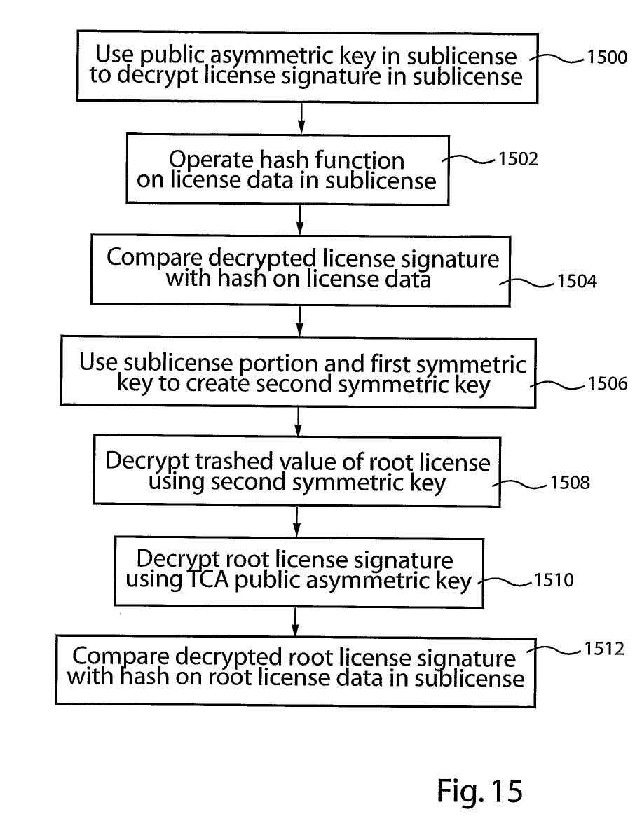

For example, there are many conceivable alternatives of providing and verifying authenticity and integrity in a chain of license files. FIGS. 14-15 illustrates an alternative to the embodiment described above in relation to FIGS. 9-10. As will be described in the following, the embodiment in FIGS. 14-15 is based on migrating an asymmetrically encrypted root Administrator License in the sublicenses, to provide authenticity and integrity. The embodiment has been designed to reduce the need of exchanging certificates/encryption keys between licensee and licensor, and to reduce the size of the resulting sublicenses.

When a root Administrator License is generated, a root license signature (License0.sf) is created. The creation of the root license signature may comprise operating a hash function on the root license data, to create a manageable data size. The root license data typically includes a root license specification (License0.txt) that defines the root Administrator License. Thereafter, the hashed root license data is encrypted with a private key of an asymmetric key-pair to create the root license signature (License0.sf). The asymmetric key-pair is created by or for the TCA, and the public key of the asymmetric key-pair is made available to the License Manager Tool, Paplet Development Tool, Paplet Installation Tool and the Paplet OS, as applicable, to enable the root license signature to be decrypted. This root license signature ensures authenticity and integrity of the root Administrator License, as explained further below.

When a sublicense (such as an Administrator License) is to be created from the root Administrator License, two mechanisms for security are embedded. The TCA may use a unique asymmetric key-pair for each sublicense. The public key (PubKey1) is included in the license data of the sublicense, together with the license specification (License1.txt). The TCA may create a license signature (License1.sf) by operating a hash function on the license data and encrypting the hashed license data with the private key of the unique asymmetric key-pair. This license signature (License1.sf) provides a first mechanism for security.

Further, the root Administrator License is included in the sublicense in order to enable verification that the sublicense is authentic and has not been tampered with. To prevent illicit re-use of the root Administrator License by someone extracting the root license portion from the sublicense, the root license signature (License0.sf) may be replaced by a reversibly modified value, denoted “trashed value” in the following. Suitably, the trashed value is generated as a function of the non-root license portion of the sublicense, thereby interconnecting the root license portion and the non-root license portion of the sublicense.

In one embodiment, the TCA uses a first symmetric key, which is shared with the above-mentioned Tools and/or the Paplet OS, as applicable, to create a second symmetric key. The second symmetric key may be created as a function of the first symmetric key and at least part of the non-root license portion of the sublicense. In one example, the function comprises an XOR-function of the first symmetric key and a hash of the license signature (License1.sf). The second symmetric key is then used for encrypting the root license signature (License0.sf), to create the trashed value. This trashed value of the root license signature provides the second mechanism for security.

In this embodiment, whenever a sublicense is created from a parent license, the two mechanisms for security are embedded in the sublicense as described above. Thus, a Developer License may be created in a License Manager Tool, based on the Administrator License, to include the root Administrator License, a license specification (License2.txt), a license signature (License2.sf) created using the private key of a unique asymmetric key-pair, and the corresponding public key (PubKey2). Further, the root license signature may be replaced by a trashed value as described above.

Similarly, a paplet package may be created in a Paplet Development Tool, based on the Developer License, to include the root Administrator License, a license specification (License3.txt), a license signature (License3.sf) created using the private key of a unique asymmetric key-pair, and the corresponding public key (PubKey3). Further, the root license signature is replaced by a trashed value as described above.

Referring now to FIG. 15, a method for verification of authenticity and integrity of a sublicense will be described. The verification may be carried out when the sublicense is imported into one of the above-mentioned Tools and/or when a paplet package is installed by a Paplet OS. In this verification, the public asymmetric key (PubKey1/2/3) is derived from the sublicense and used to decrypt the license signature in the sublicense (step 1500). This will recreate the original hash of the license data. The hash function is then operated on the license data (step 1502), and the result is compared with the original hash as obtained by decrypting the license signature (step 1504). If these values differ, the sublicense has been manipulated or tampered with after its creation. Thus, this check will verify the integrity of the license data.

Next, the second symmetric key is re-created as a function of the first symmetric key (which is available to the Tool/Paplet OS) and aforesaid non-root license portion of the sublicense (step 1506). The second symmetric key is then used in decrypting the trashed value of the root license (step 1508), thereby re-creating the root license signature. Thereafter, the root license signature is decrypted using the public asymmetric key of the TCA, which is available to the Tool/Paplet OS (step 1510). This decrypted root license signature represents an original hash value of the root license data. The relevant hash function is then operated on the root license data in the sublicense, and the resulting hash value is compared to the original hash value (step 1512). If these two hash values are equal it may be concluded that the root license data has not been manipulated or tampered with and that the root license is authentic, in that it originates from the TCA.

Yet other alternative embodiments for providing and validating authenticity and integrity in a chain of license files are described by the Applicant in WO2006/041387, which is herewith incorporated by reference.

Alternative embodiments of the Paplet OS are disclosed in Applicant's co-pending International Application No. PCT/SE2007/000159, which is incorporated herein by this reference.

It should be realized that paplets need not be associated with predefined pattern units, such as the above pattern pages. Instead, a paplet could be associated with an area address indicating an arbitrary subset of a pattern page, for example a polygonal area defined in local positions. Alternatively, the area address could be given without reference to pattern pages, e.g. by indicating an area in global positions. The present invention could also be implemented based on alternative patterns that encode position data in the form a page identifier and a local position, wherein paplets could be associated with a page identifier, optionally in combination with a local area defined in local positions. Such patterns are known from, e.g., U.S. Pat. No. 5,661,506; U.S. Pat. No. 6,330,976; WO 00/31682; and WO 00/72110. Yet other types of coding patterns are known from U.S. Pat. No. 5,442,147; U.S. Pat. No. 5,852,434; and U.S. Pat. No. 5,937,110.

In fact, the Paplet OS could operate on any type of position data, be it relative or absolute, as long as different position data can be correlated to different paplets. For example, GB 2306669 discloses an electronic pen that uses gyroscopic and pen pressure data to reconstruct the locus of the pen point while writing on a substrate. The pen also has an image sensor for recording a substrate identifier via a bar code on the substrate. Thus, position data can be recorded in the form of a substrate identifier and relative or absolute positions on the substrate. Corresponding principles are disclosed in U.S. Pat. No. 5,900,943 and U.S. Pat. No. 5,629,499.

1-29. (canceled)

30. A handheld device which operates on position data to selectively activate internal device functions, comprising:
a control system which allows for installation of application packages to impart different position data processing abilities to the handheld device, wherein each application package comprises a license specification and an application program which is configured to access said position data and said device functions via said control system;
wherein the control system is configured to verify the application program for installation based on the license specification.

31. The handheld device of claim 30, further comprising a memory which stores identification data, wherein the control system is configured to accept the application package only if there is a correspondence between an identification parameter value in the license specification and the identification data stored in the memory of the device.

32. The handheld device of claim 31, wherein the identification parameter value comprises a device ID which is uniquely associated to the handheld device.

33. The handheld device of claim 31, wherein the identification parameter value is a user ID which is uniquely associated to a user of the handheld device.

34. The handheld device of claim 33, wherein the user ID indicates an individual, a family, an organization or a company.

35. The handheld device of claim 33, wherein the control system is operable to register a user by adding a corresponding user ID to the identification data.

36. The handheld device of claim 35, wherein the identification data comprises a device ID which is uniquely associated to the handheld device, and wherein the control system is operable to register a user based on receipt of a user activation license which includes a first ID and a second ID, wherein the control system includes the first ID as user ID in the identification data only if the second ID matches said device ID.

37. The handheld device of claim 30, wherein the license specification further comprises a position data parameter which defines licensed position data, and wherein the control system, based on the license specification, selectively allows the application program to access the licensed position data.

38. The handheld device of claim 30, wherein the license specification further comprises a device function parameter which defines licensed device functions, and wherein the control system, based on the license specification, selectively allows the application program to access the licensed device functions.

39. The handheld device of claim 38, wherein said licensed device functions comprise at least one of: pre-stored media, audio player functionality, display functionality, video player functionality, handwriting recognition, text-to-speech conversion, network connection functionality, data output functionality, data encryption functionality, and bar code reading functionality.

40. The handheld device of claim 30, wherein the license specification further comprises a validity period parameter which defines a validity period, and wherein the control system, based on the license specification, allows the application program to access said position data and/or said device functions only during the validity period.

41. The handheld device of claim 30, wherein the application package further comprises a digital signature of the application program, and wherein the control system verifies the integrity of the application program by validating the digital signature.

42. The handheld device of claim 30, wherein the application package further comprises a digital signature of the license specification, and wherein the control system verifies the integrity of the license specification by validating the digital signature.

43. The handheld device of claim 30, wherein the application package includes a chain of license specifications, each link in the chain representing granting of a sublicense based on a parent license, and wherein the control system validates each link by checking that the value of at least one controlling parameter in the license specification of the sublicense does not exceed the value of said at least one controlling parameter in the license specification of the parent license.

44. The handheld device of claim 30, wherein the application package further comprises authentication data, and wherein the control system verifies the authenticity of the license specification based on said authentication data.

45. The handheld device of claims 43 and 44, wherein the authentication data comprises, for each link in the chain, a public encryption key of the receiver of the license specification, digitally signed by the issuer of the license specification.

46. The handheld device of claim 30, wherein the application program comprises at least one Java class file, and wherein the control system comprises a Java Virtual Machine and core classes.

47. A method of configuring a handheld device which operates on position data to selectively activate internal device functions, said method comprising:
receiving an application package which comprises a license specification and an application program, the application program being configured to access said position data and said device functions via a control system in the handheld device, and
verifying the application program for installation in association with said control system, based on the license specification.

48. The method of claim 47, which is executed by the control system.

49. The method of claim 47, which is executed by an installation tool in communication with the handheld device.

50. An application package for installation in a handheld device to impart a dedicated position data processing ability to a control system in the handheld device, said application package comprising:
an application program which is configured to access position data and functions of the handheld device, via said control system, and
a license specification,
wherein the license specification is intended to be used for verifying the application program before installation.

51. A method of activating a handheld device which comprises a control system capable of installing application programs that impart different position data processing capabilities to the handheld device, said method comprising:
deriving a device ID from a memory of the handheld device,
including the device ID in a user activation request which is transmitted to a license issuer,
receiving a user activation license including a first ID and a second ID, and
storing the first ID as a user ID in the memory of the handheld device, only if the second ID matches the device ID, thereby activating the control system to accept application programs associated with the user ID.

52. The method of claim 51, wherein the user ID is uniquely associated to a user of the handheld device.

53. The method of claim 51, wherein the device ID is uniquely associated to the handheld device.

54. The method of claim 51, further comprising verifying the integrity and the authenticity of the user activation license.

55. The method of claim 51 which is executed by the control system.

56. The method of claims 51, which is executed by an installation tool in communication with the handheld device.

57. A handheld device which operates on position data to selectively activate internal device functions, comprising:
a control system which is configured to allow for installation of application packages to impart different position data processing abilities to the handheld device, wherein each application package comprises a license specification and an application program which is configured to access said position data and said device functions via said control system;
wherein the license specification comprises a device function parameter which defines licensed device functions, and
wherein the control system is configured to, based on the license specification, selectively allow the application program to access the licensed device functions.

58. An application package for installation in a handheld device to impart a dedicated position data processing ability to a control system in the handheld device, said application package comprising:
an application program which is configured to access position data and functions of the handheld device, via said control system, and
a license specification which comprises a device function parameter which defines licensed device functions,
wherein the license specification is intended to cause the control system to selectively allow the application program to access said licensed device functions.
